(19) United States
(12) Patent Application Publication
(10) Pub. No.: US 2022/0248083 A1
(43) Pub. Date: Aug. 4, 2022

(54) METHOD AND APPARATUS FOR VIDEO PLAYING

(71) Applicant: BEIJING DAJIA INTERNET INFORMATION TECHNOLOGY CO., LTD., Beijing (CN)

(72) Inventors: Longcheng Shuai, Beijing (CN); Peng Cang, Beijing (CN); Jinhai Li, Beijing (CN); Tao Wang, Beijing (CN); Yuxin Liu, Beijing (CN); Pengcheng Jiang, Beijing (CN)

(21) Appl. No.: 17/728,393

(22) Filed: Apr. 25, 2022

Related U.S. Application Data
(63) Continuation of application No. PCT/CN2021/072282, filed on Jan. 15, 2021.

(30) Foreign Application Priority Data
Jan. 17, 2020 (CN) 202010054986.6

(51) Int. Cl. H04N 21/44; H04N 21/472

(52) U.S. Cl. CPC H04N 21/44; H04N 21/47217; H04N 21/47202

(57) ABSTRACT

A method for video playing includes: obtaining a target video file and a target audio file associated with a target video; determining first audio information, second audio information and image information included in the target video file, wherein the first audio information is audio information associated with the image information; playing the target video according to the first audio information, the image information and the target audio file.

### CROSS-REFERENCE TO RELATED APPLICATION

This application is a continuation application of International Application PCT/CN2021/072282, filed on Jan. 15, 2021, which claims priority to Chinese Patent Application No. 202010054986.6, filed on Jan. 17, 2020, the entire contents of which are incorporated herein by reference.

### TECHNICAL FIELD

The present disclosure relates to the field of audio and video technologies, and in particular, to a method and an apparatus for video playing.

### BACKGROUND

In the related art, in order to present the video playing effect, in addition to images and sound information closely related to the images, various sound information such as background music is mostly added to the video. When the video is played, all the information will be presented at the same time, and the relevant background music and other sounds cannot be dynamically replaced according to the needs.

### SUMMARY

According to some embodiments of the present disclosure, a method for video playing is provided. The method includes: obtaining a target video file and a target audio file associated with a target video; determining first audio information, second audio information and image information included in the target video file, wherein the first audio information is audio information associated with the image information; playing the target video according to the first audio information, the image information and the target audio file.

According to some embodiments of the present disclosure, an electronic device is provided. The electronic device includes: a processor; and a memory, configured to store instructions executable by the processor, wherein the processor is configured to execute the instructions, to implement steps of:

obtaining a target video file and a target audio file associated with a target video;

determining first audio information, second audio information and image information included in the target video file, wherein the first audio information is audio information associated with the image information;

playing the target video according to the first audio information, the image information and the target audio file.

According to some embodiments of the present disclosure, a non-transitory storage medium is provided. When instructions in the storage medium are executed by a processor of an electronic device, the electronic device is enabled to implement following steps:

obtaining a target video file and a target audio file associated with a target video;

determining first audio information, second audio information and image information included in the target video file, wherein the first audio information is audio information associated with the image information;

playing the target video according to the first audio information, the image information and the target audio file.

It is to be understood that the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure, and together with the description, serve to explain the principles of the present disclosure and do not unduly limit the present disclosure.

FIG. 1 is a schematic diagram of an application environment of a method for video playing according to an exemplary embodiment.

FIG. 2 is a flowchart of a method for video playing according to an exemplary embodiment.

FIG. 3 is a schematic diagram of a first target video in a specific scene according to an exemplary embodiment.

FIG. 4 is a flowchart showing detailed steps of step S23 according to an exemplary embodiment.

FIG. 5 is a block diagram of an apparatus for video playing according to an exemplary embodiment.

FIG. 6 is a schematic diagram of an electronic device according to an exemplary embodiment.

### DETAILED DESCRIPTION

In order to enable ordinary skilled in the art to better understand the technical solutions in this disclosure, the technical solutions in embodiments of this disclosure will be clearly and completely described in combination with the attached drawings below.

It should be noted that terms “first”, “second”, etc., in the specification and claims of the disclosure and in the appended drawings are used to distinguish similar objects and need not be used to describe a particular order or sequence. It should be understood that the data so used are interchangeable, where appropriate, so that embodiments of this disclosure described here may be implemented in a sequence other than those illustrated or described here. The implementations described in the following embodiments do not represent all implementations consistent with this disclosure. Rather, they are merely examples of devices and methods consistent with some aspects of this disclosure as detailed in the attached claims. All the embodiments of the present disclosure may be implemented independently or in combination with other embodiments, which are not limited in the present disclosure.

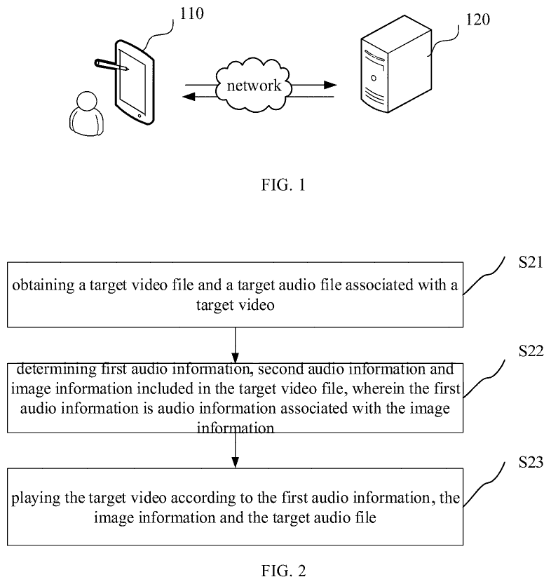

The method for video playing provided by the present disclosure can be applied to the application environment shown in FIG. 1. The terminal 110 interacts with the server 120 through the network. The terminal 110 may be, but is not limited to, various personal computers, notebook computers, smart phones, tablet computers and portable wearable devices, and the server 120 may be implemented by an independent server or a server cluster composed of multiple servers.

The terminal 110 obtains a target video file and a target audio file associated with a target video from the server or locally (i.e., from the terminal 110). The terminal 110 determines first audio information, second audio information, and image information included in the target video file, in which the first audio information is audio information associated with the image information, for example, the first audio information may include sounds made by moving objects (people, animals, etc.) in the image, and the second audio information may be background music that is not closely related to the image, etc., and plays the target video according to the first audio information, the image information and the target audio file, which realizes an effect of dynamically replacing related background music (second audio information) and other sounds according to needs.

FIG. 2 is a flowchart of a method for video playing according to an exemplary embodiment. As shown in FIG. 2, the method for video playing is applied to the terminal 110 of FIG. 1 and includes the following steps.

In step S21, a target video file and a target audio file associated with a target video are obtained.

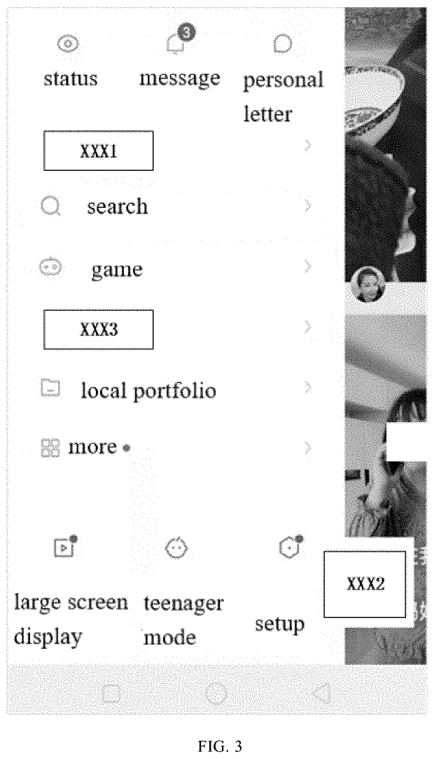

In embodiments of the present disclosure, an interface of an APP includes several video information components, and the video information component is an interface component that displays video-related information, and content displayed by the component includes one or more video-related information, such as video-related text, hyperlinks, images, short overview videos, buttons, icons, etc. For ease of understanding, an example is given here. As shown in the blocks of FIG. 3, “XXX1”, “XXX2”, “XXX3”, etc. are all video information components. When a target video information component is clicked, the terminal obtains the target video file and the target audio file associated with the target video in response to the click operation. The target audio file is preset background music associated with the target video file. In some embodiments, for each video, an association relationship between the video and audio file is preset on the server. At the same time when the target video file is obtained, the target audio file associated with the target video file is obtained according to the association relationship.

In step S22, first audio information, second audio information and image information included in the target video file are determined, wherein the first audio information is audio information associated with the image information.

The first audio information is audio information associated with the image information. For example, the first audio information may include sound made by a moving object (human, animal, etc.) in the image, and mouth movement of the object is required matching with the audio information. If the mouth movement of the object does not match the audio, it is prone to inconsistency between the sound and the image, such as various problems such as the inappropriate mouth shape.

The second audio information may be background music that is not closely related to the image, or the like.

In some embodiments, step S22 includes: decoding the target video file to obtain the first audio information of a first channel, the second audio information of a second channel and the image information.

In embodiments of the present disclosure, the terminal performs separation processing on the target video file to obtain image information and a two-channel audio file, and then decodes the two-channel audio file to obtain the first audio information of the first channel, and the second audio information of the second channel.

The two-channel means that there are two sound channels, for example, the first channel and the second channel (also called a left channel or a right channel for users), as described in the above steps, the two-channel audio file includes the first audio information and the second audio information. Generally, when two-channel playing is used, the first audio information is played in one channel, and the second audio information is played in the other channel.

In step S23, the target video is played according to the first audio information, the image information and the target audio file.

In embodiments of the present disclosure, the target video is played according to the first audio information, the image information and the target audio file, so that the second audio information does not appear when the target video is played, which achieves an effect of dynamically replacing sound such as related background music (the second audio information) according to needs.

In the above-mentioned method for video playing, the target video file and the target audio file associated with the target video (this target audio file is not the audio file in the target video file) are obtained, and the first audio information, the second audio information and the image information included in the target video file are determined, wherein the first audio information is audio information associated with the image information, for example, the first audio information may be the sound made by a moving object (person, animal, etc.) in the image, and the second audio information may be background music that is not closely related to the image, etc. After that, the target video is played according to the first audio information, the image information and the target audio file, that is, the effect of dynamically replacing the relevant background music (second audio information) and other sounds according to requirements is realized.

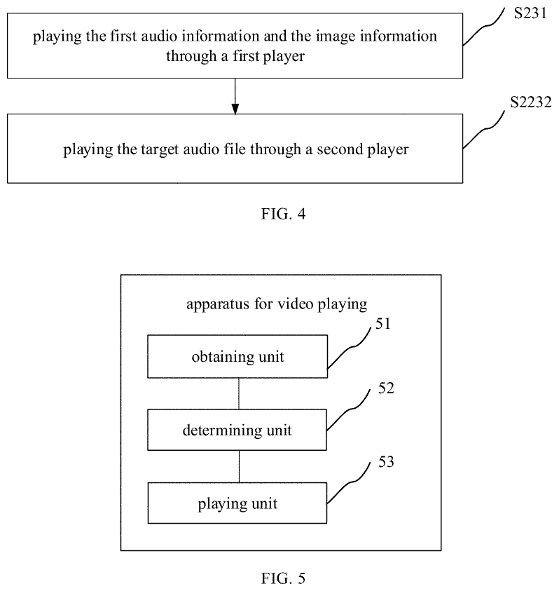

FIG. 4 is a flowchart showing detailed steps of step S23 according to an exemplary embodiment, including:

in step S231, playing the first audio information and the image information through a first player; and

in step S232, playing the target audio file through a second player.

In embodiments of the present disclosure, the terminal is provided with two players, namely the first player and the second player. The two players play different files. The first player plays the first audio information and image information in the target video file, and the second player plays the target audio file.

In some embodiments, the detailed steps further include: filling the second channel with the first audio information to replace the second audio information.

Step S231 includes: playing the first audio information of the first channel, the first audio information of the second channel and the image information through the first player.

In an embodiment of the present disclosure, the first audio information is filled into the second channel to replace the second audio information.

In some embodiments, the first audio information and the second audio information may be processed according to a sound effect localization algorithm (Audio Filter algorithm), and the first audio information is filled into the second channel to replace the second audio information. In the case where the first audio information is not filled into the second channel, but the second audio information is directly deleted, in response to using the first player to play, it will cause that after putting on earphones, sound only comes out from one earphone. By filling the second channel with the first audio information to replace the second audio information, when the first audio player is used to play, can the user's voice be heard by both earphones. In response to playing the first audio information, the first player will also play the image information at the same time, and the second player will also play the target audio file at the same time, which realizes the effect of dynamically replacing the relevant background music (the second audio information) and other sounds according to the requirements.

In some embodiments, before obtaining the target video file and the target audio file associated with the target video, the method further includes:

detecting whether the target video is a video associated with a preset page and/or a preset time;

obtaining the target video file and the target audio file associated with the target video based on whether the target video is the video associated with the preset page and/or the preset time;

based on a fact that the target video is not the video associated with the preset page and/or the preset time, starting the first player to play the target video.

The preset page may be an activity page in a specific scene (which may be but is not limited to a festival and other scenes), and the preset time is a specific time (which may be but not limited to a festival and other time). As shown in FIG. 3, in response to clicking on the video information component “XXX1” or the video information component “XXX2”, a preset page will be entered, and in response to clicking on the video information component “XXX3”, a non-preset page will be entered. Or, in response to the preset time (assuming the Spring Festival), clicking on a certain video information component will enter the preset page. The video associated with the preset page and/or the preset time needs to execute the solution, that is, obtaining the target video file and the target audio file associated with the target video (the target audio file is not the audio in the target video file), determining the first audio information, the second audio information and the image information included in the target video file, wherein the first audio information is audio information associated with the image information, for example, the first audio information may be sound made by moving objects (people, animals, etc.), and the second audio information may be background music that is not closely related to the image, etc., and after that, playing the target video according to the first audio information, the image information and the target audio file, that is, to achieve the effect of dynamically replacing relevant background music (second audio information) and other sounds according to requirements.

Based on the target video being the video associated with the preset page and/or the preset time, the first player is started to play the target video.

In some embodiments, whether the target video is a video associated with the preset page and/or the preset time may be determined first, and based on the target video being not the video associated with the preset page or the preset time, the first player is automatically called, and not any operation is performed on the second player. The terminal sends an address where the file is stored to the first player, and the first player can obtain the target video file according to the received address, and decode, render and play the target video file. The target video file is not processed by such as filling and replacing with background sound, so as to realize the normal playing of the video associated with the non-preset page and/or the non-preset time.

In embodiments of the present disclosure, the terminal is provided with two players, namely the first player and the second player, and in response to detecting a playing request for the target video, the terminal can first determine whether the target video is the video associated with the preset page and/or the preset time, based on the target video being the video associated with the preset page and/or the preset time, automatically call the first player and the second player, and sends two addresses where the files are stored to the two players respectively. The first player can obtain the target video file according to the received address, and the second player can obtain the target audio file according to the received address. After that, the terminal separates the target video file to obtain the image information and a two-channel audio file, and then decodes the two-channel audio file to obtain the first audio information of the first channel and the second audio information of the second channel, wherein, when decoding, the obtained files are automatically loaded into the first channel and the second channel, and the first audio information is filled into the second channel to replace the second audio information. After that, the first audio information, the image information and the target audio file are sent to the rendering module of the terminal for rendering, so as to play the rendered first audio information of the first channel and the second channel and image information through the first player, and play the target audio file through the second player. The effect of dynamically replacing relevant background music (second audio information) and other sounds according to requirements is realized.

It should be understood that although the steps in the flowcharts of FIG. 2 and FIG. 4 are shown in sequence according to the arrows, these steps are not necessarily executed in the sequence shown by the arrows. Unless explicitly stated herein, the execution of these steps is not strictly limited to the order, and these steps may be performed in other orders. Moreover, at least a part of the steps in FIG. 2 and FIG. 4 may include multiple steps or multiple stages. These steps or stages are not necessarily executed and completed at the same time, but may be executed at different times. The execution order of these steps or stages is also not necessarily sequential, but may be performed alternately or in turn with other steps or at least a portion of the steps or phases within the other steps.

FIG. 5 is a block diagram of an apparatus for video playing according to an exemplary embodiment. Referring to FIG. 5, the apparatus includes an obtaining unit 51, a determining unit 52 and a playing unit 53.

The obtaining unit 51 is configured to obtain a target video file and a target audio file associated with a target video.

The determining unit 52 is configured to determine first audio information, second audio information and image information included in the target video file, wherein the first audio information is audio information associated with the image information.

The playing unit 53 is configured to play the target video according to the first audio information, the image information and the target audio file.

In an exemplary embodiment, the determining unit 52 may be further configured to:

decode the target video file to obtain the first audio information of a first channel, the second audio information of a second channel and the image information.

In an exemplary embodiment, the playing unit 53 may be further configured to:

play the first audio information and the image information through a first player;

play the target audio file through a second player.

In an exemplary embodiment, the apparatus for video playing may further include a filling unit, configured to fill the second channel with the first audio information to replace the second audio information.

The playing unit 53 may be further configured to:

play the first audio information of the first channel, the first audio information of the second channel and the image information through the first player.

In an exemplary embodiment, the apparatus for video playing may further include a detecting unit configured to:

detect whether the target video is a video associated with a preset page and/or a preset time;

obtain the target video file and the target audio file associated with the target video based on whether the target video is the video associated with the preset page and/or the preset time;

based on a fact that the target video is not the video associated with the preset page and/or the preset time, start the first player to play the target video.

Regarding the apparatus in the above embodiments, the specific manner in which each module performs the operation has been described in detail in the embodiments of the method, and will not be described in detail here.

In an exemplary embodiment, an electronic device is provided. The electronic device includes a processor and a memory configured to store instructions executable by the processor. The processor is configured to execute the instructions, to implement the method for video playing as in embodiments of the present disclosure.

In an exemplary embodiment, a storage medium is provided. When instructions in the storage medium are executed by a processor of an electronic device, the electronic device is enabled to implement the method for video playing in embodiments of the present disclosure.

In an exemplary embodiment, a computer program product including instructions is provided. When the computer program product is running on a computer, the computer is enabled to implement the method for video playing in embodiments of the present disclosure.

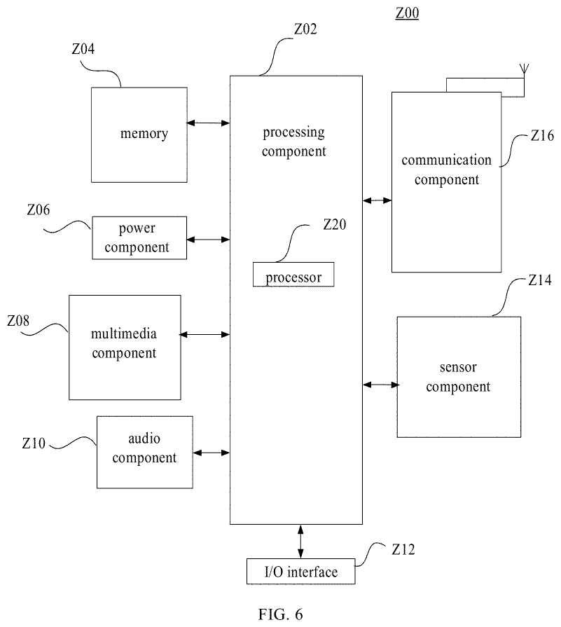

FIG. 6 is a block diagram illustrating an electronic device Z00 according to an example embodiment. As illustrated in FIG. 6, the electronic device Z00 may be a computer, a mobile phone, a digital broadcasting terminal, a messaging transceiver, a game console, a tablet device, a medical equipment, a fitness equipment, a personal digital assistant, etc.

Referring to FIG. 6, the electronic device Z00 may include one or more of the following components: a processing component Z02, a memory Z04, a power component Z06, a multimedia component Z08, an audio component Z10, an input/output (I/O) interface Z12, a sensor component Z14 and a communication component Z16.

The processing component Z02 typically controls overall operations of the electronic device Z00, such as the operations associated with display, data communications, telephone call, camera operations, and recording operations. The processing component Z02 may include one or more processors Z20 to execute instructions so as to perform all or part of the steps in the above described methods. Moreover, the processing component Z02 may include one or more modules which facilitate the interaction between the processing component Z02 and other components. For instance, the processing component Z02 may include a multimedia module to facilitate the interaction between the multimedia component Z08 and the processing component Z02.

The memory Z04 is configured to store various types of data to support the operation of the electronic device Z00. Examples of such data include instructions for any applications or methods operated on the electronic device Z00, contact data, phonebook data, messages, pictures, videos, etc. The memory Z04 may be implemented using any type of volatile or non-volatile memory device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component Z06 provides power to various components of the electronic device Z00. The power component Z06 may include a power management system, one or more power sources, and any other components associated with the generation, management, and distribution of power in the electronic device Z00.

The multimedia component Z08 includes a screen providing an output interface between the electronic device Z00 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action. In some embodiments, the multimedia component Z08 includes a front camera and/or a rear camera. The front camera and/or the rear camera may receive an external multimedia datum while the electronic device Z00 is in an operation mode, such as a photographing mode or a video mode. Each of the front camera and the rear camera may be a fixed optical lens system or have focus and optical zoom capability.

The audio component Z10 is configured to output and/or input an audio signal. For example, the audio component Z10 includes a microphone (“MIC”) configured to receive an external audio signal when the electronic device Z00 is in an operation mode, such as a call mode, a recording mode, and a voice recognition mode. The received audio signal may be further stored in the memory Z04 or transmitted via the communication component Z16. In some embodiments, the audio component Z10 further includes a speaker to output audio signals.

The I/O interface Z12 provides an interface between the processing component Z02 and peripheral interface modules, such as a keyboard, a click wheel, buttons, and the like. The buttons may include, but are not limited to, a home button, a volume button, a starting button, and a locking button.

The sensor component Z14 includes one or more sensors to provide status assessments of various aspects of the electronic device Z00. For instance, the sensor component Z14 may detect an opened/closed status of the electronic device Z00, relative positioning of components (e.g., the display and the keypad) of the electronic device Z00, a change in position of the electronic device Z00 or a component of the electronic device Z00, a presence or absence of user contact with the electronic device Z00, an orientation or an acceleration/deceleration of the electronic device Z00, and a change in temperature of the electronic device Z00. The sensor component Z14 may include a proximity sensor configured to detect the presence of nearby objects without any physical contact. The sensor component Z14 may also include a light sensor, such as a CMOS or CCD image sensor, for use in imaging applications. In some embodiments, the sensor component Z14 may also include an accelerometer sensor, a gyroscope sensor, a magnetic sensor, a pressure sensor, or a temperature sensor.

The communication component Z16 is configured to facilitate wired or wireless communication between the electronic device Z00 and other apparatus. The electronic device Z00 can access a wireless network based on a communication standard, such as WiFi, 2G, or 3G, or a combination thereof. In one exemplary embodiment, the communication component Z16 receives a broadcast signal or broadcast associated information from an external broadcast management system via a broadcast channel. In one exemplary embodiment, the communication component Z16 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the electronic device Z00 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

Those of ordinary skill in the art can understand that all or part of the processes in the methods of the above embodiments can be implemented by instructing relevant hardware through a computer program, and the computer program can be stored in a non-volatile computer-readable storage medium. When the computer program is executed, it may include the processes of the above-mentioned method embodiments. Any reference to memory, storage, database, or other medium used in the various embodiments provided in this disclosure may include non-volatile and/or volatile memory. Nonvolatile memory may include read only memory (ROM), programmable ROM (PROM), electrically programmable ROM (EPROM), electrically erasable programmable ROM (EEPROM), or flash memory. Volatile memory may include random access memory (RAM) or external cache memory. By way of illustration and not limitation, RAM is available in various forms such as static RAM (SRAM), dynamic RAM (DRAM), synchronous DRAM (SDRAM), double data rate SDRAM (DDRSDRAM), enhanced SDRAM (ESDRAM), synchronous chain Road (Synchlink) DRAM (SLDRAM), memory bus (Rambus) direct RAM (RDRAM), direct memory bus dynamic RAM (DRDRAM), and memory bus dynamic RAM (RDRAM) and so on.

The technical features of the above embodiments can be combined arbitrarily. For the sake of brevity, all possible combinations of the technical features in the above embodiments are not described. However, as long as there is no contradiction in the combination of these technical features, all is considered to be the range described in this specification.

The above-mentioned embodiments only represent several embodiments of the present disclosure, and the descriptions thereof are specific and detailed, but should not be construed as limiting the scope of the invention. It should be noted that, for those skilled in the art, without departing from the concept of the present disclosure, several modifications and improvements can be made, which all belong to the protection scope of the present disclosure. Accordingly, the scope of protection of the present disclosure should be determined by the appended claims.

What is claimed is:

1. A method for video playing, comprising:
obtaining a target video file and a target audio file associated with a target video;
determining first audio information, second audio information and image information included in the target video file, wherein the first audio information is audio information associated with the image information;
playing the target video according to the first audio information, the image information and the target audio file.

2. The method according to claim 1, wherein determining the first audio information, the second audio information and the image information included in the target video file comprises:
decoding the target video file to obtain the first audio information of a first channel, the second audio information of a second channel and the image information.

3. The method according to claim 1, wherein playing the target video according to the first audio information, the image information and the target audio file comprises:
playing the first audio information and the image information through a first player;
playing the target audio file through a second player.

4. The method according to claim 3, further comprising:
filling the second channel with the first audio information to replace the second audio information;
playing the first audio information of the first channel, the first audio information of the second channel and the image information through the first player.

5. The method according to claim 1, further comprising:
detecting whether the target video is a video associated with a preset page and/or a preset time;
obtaining the target video file and the target audio file associated with the target video based on whether the target video is the video associated with the preset page and/or the preset time;
based on a fact that the target video is not the video associated with the preset page and/or the preset time, starting the first player to play the target video.

6. The method according to claim 1, wherein the second audio information comprises background music that is not closely related to the image information.

7. An electronic device, comprising:
a processor; and
a memory, configured to store instructions executable by the processor,
wherein the processor is configured to execute the instructions, to implement steps of:
obtaining a target video file and a target audio file associated with a target video;
determining first audio information, second audio information and image information included in the target video file, wherein the first audio information is audio information associated with the image information;
playing the target video according to the first audio information, the image information and the target audio file.

8. The electronic device according to claim 7, wherein the processor is further configured to implement following steps when executing the instructions:
decoding the target video file to obtain the first audio information of a first channel, the second audio information of a second channel and the image information.

9. The electronic device according to claim 7, wherein the processor is further configured to implement following steps when executing the instructions:
playing the first audio information and the image information through a first player;
playing the target audio file through a second player.

10. The electronic device according to claim 9, wherein the processor is further configured to implement following steps when executing the instructions:
filling the second channel with the first audio information to replace the second audio information;
playing the first audio information of the first channel, the first audio information of the second channel and the image information through the first player.

11. The electronic device according to claim 7, wherein the processor is further configured to implement following steps when executing the instructions:
detecting whether the target video is a video associated with a preset page and/or a preset time;
obtaining the target video file and the target audio file associated with the target video based on whether the target video is the video associated with the preset page and/or the preset time;
based on a fact that the target video is not the video associated with the preset page and/or the preset time, starting the first player to play the target video.

12. The electronic device according to claim 7, wherein the second audio information comprises background music that is not closely related to the image information.

13. A non-transitory storage medium, wherein when instructions in the storage medium are executed by a processor of an electronic device, the electronic device is enabled to implement following steps:
obtaining a target video file and a target audio file associated with a target video;
determining first audio information, second audio information and image information included in the target video file, wherein the first audio information is audio information associated with the image information;
playing the target video according to the first audio information, the image information and the target audio file.

14. The storage medium according to claim 13, wherein, when instructions stored in the storage medium are executed by the processor of the electronic device, the electronic device is further enabled to implement following steps:
decoding the target video file to obtain the first audio information of a first channel, the second audio information of a second channel and the image information.

15. The storage medium according to claim 13, wherein, when instructions stored in the storage medium are executed by the processor of the electronic device, the electronic device is further enabled to implement following steps:
playing the first audio information and the image information through a first player;
playing the target audio file through a second player.

16. The storage medium according to claim 15, wherein, when instructions stored in the storage medium are executed by the processor of the electronic device, the electronic device is further enabled to implement following steps:
filling the second channel with the first audio information to replace the second audio information;
playing the first audio information of the first channel, the first audio information of the second channel and the image information through the first player.

17. The storage medium according to claim 13, wherein, when instructions stored in the storage medium are executed by the processor of the electronic device, the electronic device is further enabled to implement following steps:
detecting whether the target video is a video associated with a preset page and/or a preset time;
obtaining the target video file and the target audio file associated with the target video based on whether the target video is the video associated with the preset page and/or the preset time;
based on a fact that the target video is not the video associated with the preset page and/or the preset time, starting the first player to play the target video.

18. The storage medium according to claim 13, wherein the second audio information comprises background music that is not closely related to the image information.
